(19) United States
(12) Patent Application Publication
(10) Pub. No.: US 2018/0103509 A1
(43) Pub. Date: Apr. 12, 2018

(54) ELECTRIC OVEN INCLUDING THERMAL DIFFUSION LAYER

(71) Applicant: SAMSUNG ELECTRONICS CO., LTD., Suwon-si (KR)

(72) Inventors: Doyoon KIM, Hwaseong -si (KR); Changsoo LEE, Seoul (KR); Haengdeog KOH, Hwaseong -si (KR); Seyun KIM, Seoul (KR); Jinhong KIM, Seoul (KR); Hajin KIM, Hwaseong -si (KR); Soichiro MIZUSAKI, Suwon-si (KR); Minjong BAE, Yongin-si (KR); Hiesang SOHN, Seoul (KR)

(21) Appl. No.: 15/452,171

(22) Filed: Mar. 7, 2017

(30) Foreign Application Priority Data
Oct. 12, 2016 (KR) 10-2016-0132145

(51) Int. Cl. H05B 3/20; F24C 7/06; H05B 3/14

(52) U.S. Cl. CPC H05B 3/20; H05B 2203/007; H05B 3/146; F24C 7/06

(57) ABSTRACT

The electric oven includes a case having a tubular shape with an open front face and accommodates food therein, an inner frame in the case, which has a plurality of external surfaces and defining a cavity which is a heating region of the food, a plurality of sheet heaters arranged on the external surfaces of the inner frame, and first and second electrodes connected to opposite edges of each of the sheet heaters, respectively. A plurality of thermal diffusion layers is disposed on corners of the external surfaces of the inner frame.

### CROSS-REFERENCE TO RELATED APPLICATIONS

This application claims priority to Korean Patent Application No. 10-2016-0132145, filed on Oct. 12, 2016, and all the benefits accruing therefrom under 35 U.S.C. § 119, the disclosure of which is incorporated herein in its entirety by reference.

### BACKGROUND

### 1. Field

Provided are electric ovens including thermal diffusion layers.

### 2. Description of the Related Art

Generally, an electric oven is a cooking mechanism for heating various foods in the electric oven by increasing a temperature inside the electric oven by using electricity after sealing cooking materials therein in the electric oven. An electric oven may uniformly cook food having various sizes and shapes since the electric oven can be instantly started and stopped, the temperature control thereof is relatively easy via a power control, and various parts of the food can be simultaneously heated.

Generally, a coil heater is used as a heat source of an electric oven, and the coil heater is installed above an inner frame of the electric oven.

### SUMMARY

Provided are electric ovens including sheet heaters arranged on each external surface of an inner frame and thermal diffusion layers arranged on corners of the inner frame.

When a single heat source is used, the heat source must be operated at a high temperature in order to diffuse heat to the whole cavity in the inner frame, and thus, the heat source and the electric oven may deform and be damaged.

In addition, corner parts of the cavity may have a relatively low temperature, and thus, a large amount of energy may be required for cleaning contamination materials at the corner parts of the cavity.

These problems are caused due to the non-uniform temperature distribution in the cavity.

According to an embodiment, an electric oven includes a case having a tubular shape with an open front face and the case accommodates food therein, an inner frame in the case, having a plurality of external surfaces and defining a cavity which is a heating region of the food, a plurality of sheet heaters arranged on the external surfaces of the inner frame, first and second electrodes connected to opposite edges of each of the sheet heaters, respectively, and a plurality of thermal diffusion layers attached to corners of the external surfaces of the inner frame.

The sheet heaters may be arranged on each of the external surfaces of the inner frame.

The electric oven may further include at least one thermal diffusion layer arranged between the sheet heaters on each of the external surfaces.

The inner frame may include a plurality of concave parts that are convex towards the cavity from the external surfaces of the inner frame, and at least one of the plurality of sheet heaters may be disposed on each of the plurality of the concave parts. The electric oven may further include a plurality of thermal diffusion layers on flat parts of the external surfaces of the inner frame.

The thermal diffusion layer may extend towards the concave parts from the flat parts to cover bending parts disposed between the flat parts and the concave parts.

The sheet heaters may include a nonconductive matrix and a plurality of fillers. The plurality of fillers may include RuO₂, MnO₂, VO₂, TaO₂, IrO₂, NbO₂, WO₂, GaO₂, MoO₂, InO₂, CrO₂, or RhO₂.

The thermal diffusion layers may include aluminum, copper, or carbon.

The thermal diffusion layers may be spaced apart from the first and second electrodes and the sheet heaters.

The sheet heaters may have a thickness from about 10 micrometers (μm) to about 20 μm.

The sheet heaters may cover at least parts of surfaces of the first and second electrodes.

The first and second electrodes may include at least one of Ag, Al, indium tin oxide (ITO), Cu, Mo, and Pt.

The electric oven may further include a coating on the external surfaces of the inner frame. The thermal diffusion layers may be disposed on the coating separately from the inner frame.

The thermal diffusion layers may contact the external surface of the inner frame, and the electric oven may further include a coating on the external surface of the inner case and which covers the thermal diffusion layers.

The first and second electrodes may include a plurality of first finger electrodes and a plurality of second finger electrodes, respectively, the first finger electrodes and the second finger electrodes may be alternately arranged, and each of the plurality of the sheet heaters may be connected to one of the first finger electrodes and one of the second finger electrodes.

### BRIEF DESCRIPTION OF THE DRAWINGS

These and/or other features will become apparent and more readily appreciated from the following description of the embodiments, taken in conjunction with the accompanying drawings in which:

FIG. 1 is a schematic perspective view showing a structure of an electric oven including thermal diffusion layers according to an embodiment;

FIG. 2 is a schematic perspective view showing a structure of an inner frame of an electric oven according to an embodiment;

FIG. 3 is a cross-sectional view showing an embodiment of a portion of an electric oven taken along line III-III′ of FIG. 2;

FIG. 4 is a cross-sectional view showing an embodiment of a portion of an electric oven taken along line IV-IV′ of FIG. 2;

FIG. 5 is a schematic perspective view showing a structure of an inner frame of an electric oven according to another embodiment;

FIG. 6 is a cross-sectional view showing an embodiment of an arrangement of sheet heaters on the inner frame taken along line VI-VI′ of FIG. 5; and

FIG. 7 is a plan view showing an arrangement of sheet heaters disposed on an inner frame of an electric oven according to another embodiment.

### DETAILED DESCRIPTION

Reference will now be made in detail to embodiments, examples of which are illustrated in the accompanying drawings. In the drawings, thicknesses of layers and regions may be exaggerated for clarity of layers and regions. The embodiments of the inventive concept are capable of various modifications and may be embodied in many different forms.

Hereinafter, when an element is referred to as being “on” or “above” another element, the element may be in direct contact with the other element or other intervening elements may be present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

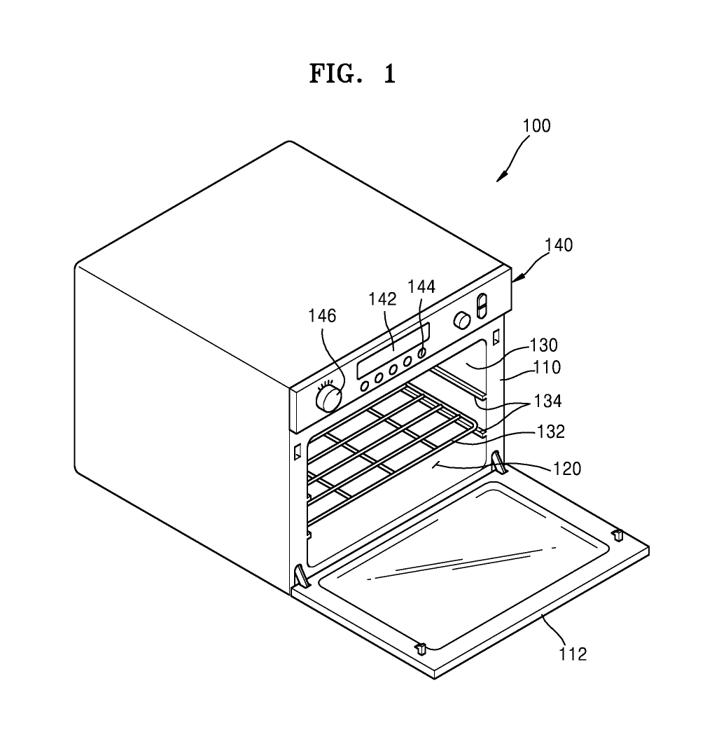

FIG. 1 is a schematic perspective view showing a structure of an electric oven 100 including a thermal diffusion layer according to an embodiment.

Referring to FIG. 1, the electric oven 100 includes a case 110 that forms an appearance and an inner frame 130 that is provided in the case 110 and defines a cavity (or a cooking space) 120. A space between the case 110 and the inner frame 130 may be filled with an insulating material (not shown). In an exemplary embodiment, the case 110 may have a rectangular tube shape having a front surface thereof opened. The case 110 may have a substantially cuboid shape.

Front surfaces of the case 110 and the inner frame 130 are open so that food can be placed in the inner frame 130. A door 112 rotates up and down by hinging on a lower part of the case 110 on a front side of the case 110.

However, the invention is not limited thereto. The door 112 may be rotated to left and right sides of the case 110 by being connected to a side of the case 110.

An operation unit 140 above the door 112 on the case 110 operates the electric oven 100. The operation unit 140 includes a display unit 142 that displays an operation state of the electric oven 100, a plurality of buttons 144, and a plurality of operation switches 146.

The inner frame 130 is separated by a predetermined gap from the case 110. Guide rails 134 that support oven racks 132 are disposed on both sidewalls facing each other of the inner frame 130. A plurality of guide rails 134 is provided to locate food in a central region of the cavity 120 according to the size of the food.

The inner frame 130 may include carbon steel. A first coating 136 (refer to FIG. 3) may be disposed on an inner surface of the inner frame 130. In an exemplary embodiment, the first coating 136 may include enamel or chrome. A second coating 138 (refer to FIG. 3) may be disposed on an external surface 130a (refer to FIG. 3) of the inner frame 130. In an exemplary embodiment, the second coating 138 may include enamel and may be used as an insulating layer.

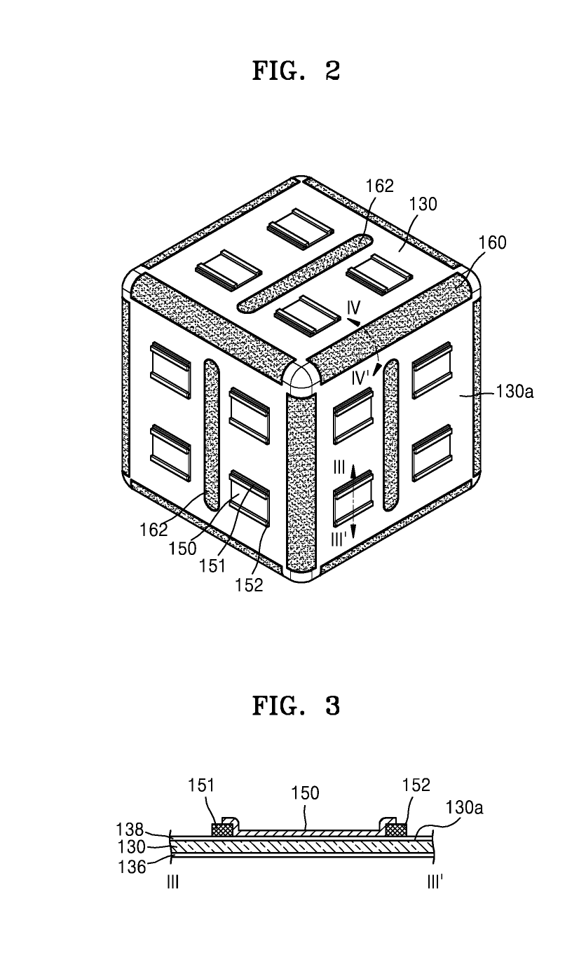

FIG. 2 is a schematic perspective view showing a structure of the inner frame 130 of the electric oven 100 according to an embodiment.

Referring to FIG. 2, the inner frame 130 may have a substantially cuboid shape, and a surface thereof is open, and thus, may include 5 surfaces. A plurality of sheet heaters 150 may be arranged on each of the external surfaces 130a of the inner frame 130. The sheet heater is a planar heat source rather than a linear heat source such as a conventional coil heater. Although in FIG. 2, 4 sheet heaters 150 are disposed on each of the external surfaces 130a of the inner frame 130, the invention is not limited thereto. In an exemplary embodiment, more than 6 sheet heaters 150 may be arranged on each of the external surfaces 130a of the inner frame 130, for example. A first electrode 151 and a second electrode 152 are arranged on opposite edges of each of the sheet heaters 150, respectively. Heat is generated from the sheet heaters 150 by current applied to the first and second electrodes 151 and 152.

FIG. 3 is a cross-sectional view showing an embodiment of a portion of the electric oven taken along line III-Ill′ of FIG. 2.

Referring to FIG. 3, the first coating 136 and the second coating 138 may be further disposed on opposite surfaces of the inner frame 130, respectively. The first and second electrodes 151 and 152 are spaced apart on the second coating 138. The sheet heater 150 may be coated on the second coating 138 and be disposed between the first and second electrodes 151 and 152. The sheet heater 150 may cover at least parts of the first and second electrodes 151 and 152.

The first coating 136 may include enamel or chrome. In an exemplary embodiment, the second coating 138 may include an insulating material, for example, enamel.

Referring to FIG. 2, thermal diffusion layers 160 may be disposed on corners of the external surfaces 130a of the inner frame 130. Thermal diffusion layers 162 may also be disposed between the sheet heaters 150 on the external surfaces 130a of the inner frame 130. The thermal diffusion layers 160 and 162 are spaced apart from the sheet heaters 150 and the first and second electrodes 151 and 152.

The sheet heaters 150 may include a nonconductive matrix and a plurality of fillers. In an exemplary embodiment, the nonconductive matrix includes a glass frit or an organic polymer. The fillers in the matrix contact each other to form a network structure as a current path in the matrix. The current path is connected to the first electrode 151 and the second electrode 152.

The glass frit may include at least two of silicon oxide, lithium oxide, nickel oxide, cobalt oxide, boron oxide, potassium oxide, aluminum oxide, titanium oxide, manganese oxide, copper oxide, zirconium oxide, phosphorus oxide, zinc oxide, bismuth oxide, lead oxide, and sodium oxide.

The filler is a conductive oxide including RuO₂, MnO₂, VO₂, TaO₂, IrO₂, NbO₂, WO₂, GaO₂, MoO₂, InO₂, CrO₂, or RhO₂.

The thermal diffusion layers 160 and 162 may include a material having a relatively high thermal conductivity. In an exemplary embodiment, the thermal diffusion layers 160 and 162 may include a material having thermal conductivity higher than that of the second coating 138 therebelow, for example. The thermal diffusion layers 160 and 162 may include aluminum, copper, or carbon, and may have a thickness from about 10 micrometers (μm) to about 20 μm, toward the external surface 130a. The thickness of the thermal diffusion layers 160 and 162 may allow the thermal diffusion layers 160 and 162 be easily coated on the inner frame 130.

It may be difficult to dispose the sheet heaters 150 on bending parts of the inner frame 130. However, the thermal diffusion layer 160 may be readily disposed on the bending parts of the inner frame 130 by using a spray method, a screen printing method, or a tape transfer method.

The first and second electrodes 151 and 152 may include Ag, Al, indium tin oxide (ITO), Cu, Mo, or Pt.

In the electric oven 100 according to an embodiment, heat generated from the sheet heaters 150 is transmitted to the cavity 120, the thermal diffusion layers 162 on each surface of the inner frame 130 and the thermal diffusion layers 160 on the corners of the inner frame 130, and thus, the phenomenon that temperature at the corners of the inner frame 130 is relatively low can be reduced. Accordingly, food in the inner frame 130 may be uniformly cooked, and relatively small amount of energy may be required in a cleaning mode.

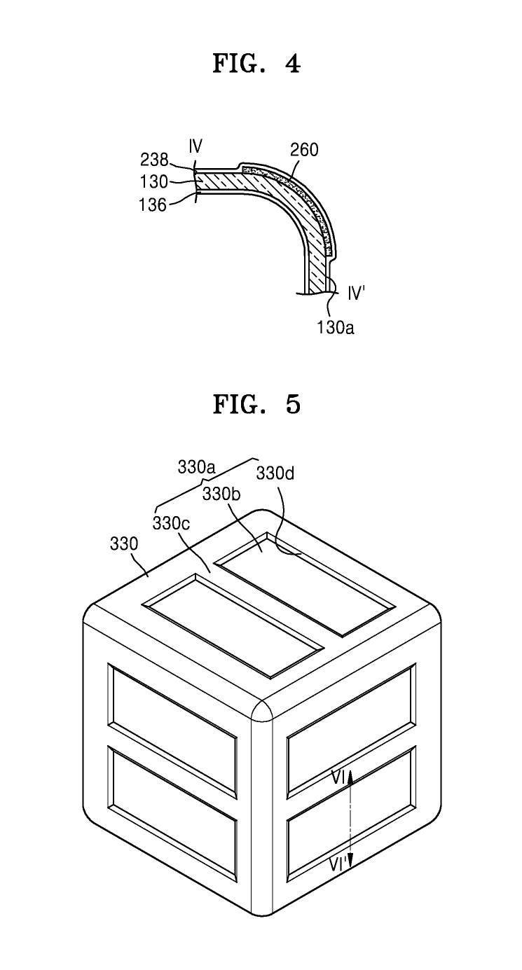

FIG. 4 is a cross-sectional view of showing an embodiment of a portion of an electric oven taken along line IV-IV′ of FIG. 2.

Referring to FIG. 4, a thermal diffusion layer 260 is provided to contact the external surface 130a of the inner frame 130. A second coating 238 may be further disposed on the external surface 130a of the inner frame 130 and cover the thermal diffusion layer 260.

Since the thermal diffusion layer 260 directly contacts the inner frame 130, heat generated from the sheet heaters 150 may be further rapidly transmitted to the thermal diffusion layer 260 through the inner frame 130, and thus, the effect of heat diffusion to the thermal diffusion layer 260 may increase.

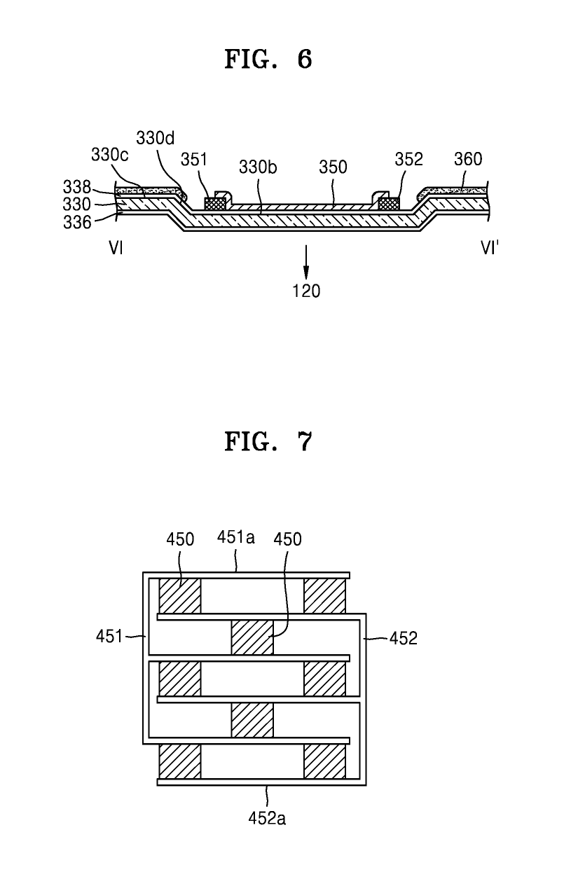

FIG. 5 is a schematic perspective view showing a structure of an inner frame 330 of an electric oven according to another embodiment. FIG. 6 is a cross-sectional view showing an embodiment of an arrangement of a sheet heater 350 on the inner frame 330 taken along line VI-VI′ of FIG. 5.

Referring to FIGS. 5 and 6, each external surface 330a of the inner frame 330 may include concave parts 330b to provide rigidity to the inner frame 330. The concave parts 330b may be convex towards the cavity 120 (refer to FIG. 1) from a flat surface 330c. A first coating 336 may be disposed on an inner surface of the inner frame 330. A second coating 338 may be further disposed on an external surface 330a of the inner frame 330. At least one sheet heater 350 is further disposed above each of the concave parts 330b, and first and second electrodes 351 and 352 are further arranged to contact opposite edges of each sheet heater 350, respectively. A thermal diffusion layer 360 may be further arranged on the flat surface 330c of the inner frame 330. The thermal diffusion layer 360 may extend towards the concave part 330b and may cover a bending portion 330d disposed between the concave part 330b and the flat surface 330c. The thermal diffusion layer 360 is spaced apart from the first and second electrodes 351 and 352. The thermal diffusion layer 360 may also be disposed on corner portions of the inner frame 330.

FIG. 7 is a plan view showing an arrangement of a sheet heater disposed on an inner frame of an electric oven according to another embodiment.

Referring to FIG. 7, first and second electrodes 451 and 452 include a plurality of first finger electrodes 451a and a plurality of second finger electrodes 452a, respectively. The first finger electrodes 451a extend to face the second electrode 452 and the second finger electrodes 452a extend to face the first electrode 451. The first finger electrodes 451a and the second finger electrodes 452a are alternately arranged. A plurality of sheet heaters 450 are arranged between the first finger electrodes 451a and the second finger electrodes 452a. Each sheet heater 450 contacts a pair of the first finger electrode 451a and the second finger electrode 452a adjacent to each other. The sheet heaters 450 may be arranged in an array.

The arrangement of the sheet heaters 450 of FIG. 7 may be disposed on a surface of the inner frame 130 of FIG. 2, and also, may be disposed on the concave parts 330b of FIG. 5.

In an electric oven that includes the first finger electrodes 451a and the second finger electrodes 452a, the sheet heaters 450 may be uniformly arranged on each surface of the inner frame of the electric oven, and accordingly, a temperature deviation on each surface of the inner frame of the electric oven may be reduced. Accordingly, the temperature deviation to the food according to the location in a cavity may be reduced, and also, energy required for cleaning operation of the electric oven may be reduced.

Heat generated from sheet heaters in an electric oven is transmitted to a cavity, and may be transmitted to thermal diffusion layers on corners of the cavity, and thus, a temperature deviation in the cavity of corners of the inner frame may be reduced. Accordingly, food in the inner frame may be uniformly cooked, and a relatively small amount of energy is required for a cleaning mode of the electric oven.

While one or more embodiments have been described with reference to the figures, it will be understood by those of ordinary skill in the art that various changes in form and details may be made therein without departing from the spirit and scope as defined by the following claims.

What is claimed is:

1. An electric oven comprising:
a case which has a tubular shape with an open front face, the case accommodates food therein;
an inner frame in the case, the inner frame having a plurality of external surfaces and defining a cavity which is a heating region for the food;
a plurality of sheet heaters arranged on the external surfaces of the inner frame;
first and second electrodes connected to opposite edges of each of the sheet heaters, respectively; and
a plurality of thermal diffusion layers attached to corners of the external surfaces of the inner frame.

2. The electric oven of claim 1, wherein the sheet heaters are arranged on each of the external surfaces of the inner frame.

3. The electric oven of claim 2, further comprising at least one thermal diffusion layer arranged between the sheet heaters on each of the external surfaces.

4. The electric oven of claim 1, wherein the inner frame comprises a plurality of concave parts that are convex towards the cavity from the external surfaces of the inner frame, and at least one of the plurality of sheet heaters is disposed on each of the plurality of concave parts.

5. The electric oven of claim 4, further comprising a plurality of thermal diffusion layers on flat parts of the external surfaces of the inner frame.

6. The electric oven of claim 5, wherein the thermal diffusion layers extend towards the concave parts from the flat parts to cover bending parts disposed between the flat parts and the concave parts.

7. The electric oven of claim 1, wherein the sheet heaters comprise a nonconductive matrix and a plurality of fillers, the plurality of fillers including RuO₂, MnO₂, VO₂, TaO₂, IrO₂, NbO₂, WO₂, GaO₂, MoO₂, InO₂, CrO₂, or RhO₂.

8. The electric oven of claim 1, wherein the thermal diffusion layer comprises aluminum, copper, or carbon.

9. The electric oven of claim 1, wherein the thermal diffusion layers are spaced apart from the first electrode, the second electrode and the sheet heaters.

10. The electric oven of claim 1, wherein the sheet heater has a thickness from about 10 micrometers (μm) to about 20 micrometers (μm).

11. The electric oven of claim 1, wherein the sheet heater covers at least parts of surfaces of the first and second electrodes.

12. The electric oven of claim 1, wherein the first and second electrodes comprise at least one of Ag, Al, indium tin oxide (ITO), Cu, Mo, and Pt.

13. The electric oven of claim 1, further comprising a coating on the external surfaces of the inner frame, wherein the thermal diffusion layers are disposed on the coating separately from the inner frame.

14. The electric oven of claim 1, wherein the thermal diffusion layers contact the external surface of the inner frame, and
further comprising a coating on the external surface of the inner frame and which covers the thermal diffusion layers.

15. The electric oven of claim 1, wherein
the first and second electrodes comprise a plurality of first finger electrodes and a plurality of second finger electrodes, respectively,
the first finger electrodes and the second finger electrodes are alternately arranged, and
each of the plurality of sheet heaters is connected to one of the first finger electrodes and one of the second finger electrodes.
